(19) United States
(12) Patent Application Publication
(10) Pub. No.: US 2024/0034095 A1
(43) Pub. Date: Feb. 1, 2024

(54) NON-PNEUMATIC TIRE WITH WEB HAVING VARIABLE THICKNESS

(71) Applicant: Bridgestone Americas Tire Operations, LLC, Nashville, TN (US)

(72) Inventor: Benjamin D. Knospe, Merrill, WI (US)

(21) Appl. No.: 18/380,324

(22) Filed: Oct. 16, 2023

Related U.S. Application Data
(63) Continuation of application No. 16/647,992, filed on Mar. 17, 2020.
(60) Provisional application No. 62/570,147, filed on Oct. 10, 2017.

(51) Int. Cl. B60C 7/08; B29D 30/02; B60C 7/10; B60C 99/00; B60C 7/14

(52) U.S. Cl. CPC B60C 7/08; B29D 30/02; B60C 7/102; B60C 99/006; B60C 7/146; B60C 7/107

(57) ABSTRACT

A non-pneumatic tire includes a generally annular inner ring that attaches to a wheel, a generally annular outer ring, and an interconnected web between the generally annular inner ring and the generally annular outer ring. The interconnected web defines a plurality of openings circumferentially spaced around the tire and radially spaced at varying distances from an axis of rotation, so as to support a load by working in tension. The interconnected web includes a plurality of web elements having a varying thickness, including a first plurality of web elements above the axis of rotation and a second plurality of web elements below the axis of rotation. The varying thickness is configured to facilitate buckling of the interconnected web. When a load is applied, the first plurality of web elements are subjected to a tensile force while the second plurality of web elements buckle.

### CROSS-REFERENCE TO RELATED APPLICATIONS

This application is a continuation of U.S. patent application Ser. No. 16/647,992, filed on Mar. 17, 2020, which is a 371 national stage entry of PCT/US2018/54839, filed on Oct. 8, 2018, which in turn claims the benefit of U.S. Provisional Patent Application No. 62/570,147, filed on Oct. 10, 2017. The disclosure of each of these documents is incorporated by reference herein in its entirety.

### FIELD OF THE INVENTION

The present disclosure is directed to a tire, and more particularly, to a non-pneumatic tire.

### BACKGROUND

Non-pneumatic, or airless, tires (NPT) have previously been made of an entirely solid substance. These solid tires made the ride rather uncomfortable for passengers and caused greater damage to the suspension of a vehicle, which had to compensate for the lack of “give” in a solid tire.

More recently, NPTs have employed spokes or webbing extending between an inner ring and an outer ring. By way of example, U.S. Published Application 2006/0113016 by Cron, et al., and assigned to Michelin, discloses a non-pneumatic tire that it commercially refers to as the Tweel™. In the Tweel™, the tire combines with the wheel. It is made up of four parts that are eventually bonded together: the wheel, a spoke section, a reinforced annular band that surrounds the spoke section, and a rubber tread portion that contacts the ground.

### SUMMARY OF THE INVENTION

In one embodiment a non-pneumatic tire includes a generally annular inner ring having an axis of rotation, a deformable generally annular outer ring, and a flexible interconnected web extending between the inner and the outer ring. The interconnected web includes at least two radially adjacent layers of web elements at every radial cross-section of the tire. The web elements define a plurality of generally polygonal openings and include a plurality of radial web elements that are angled relative to a plane that extends radially through the axis of rotation and a plurality of distinct tangential web elements that are generally transverse to the radial plane. Each generally polygonal opening is defined by a plurality of vertices. Each of the plurality of vertices is defined by an elliptical transitional element that varies a thickness of an associated web element along at least a portion of a length of the web element. When load is applied, a substantial amount of the load is supported by a plurality of the web elements working in tension. A plurality of the radial web elements in a region above the axis of rotation are subjected to a tensile force while at least some of the radial web elements in a region between the load and a footprint region buckle and a plurality of the tangential web elements distribute the load through the flexible interconnected web.

In another embodiment a method of designing a non-pneumatic tire includes a step of providing a generally annular inner ring having an axis of rotation, a step of providing a deformable generally annular outer ring, and a step of connecting the inner ring to the outer ring with a flexible interconnected web having at least two radially adjacent layers of web elements at every radial cross-section of the tire. The web elements define a plurality of generally polygonal openings having a plurality of vertices, and the web elements include a plurality of radial web elements that are angled relative to a plane that extends radially through the axis of rotation and a plurality of distinct tangential web elements that are generally transverse to the radial plane. The step of connecting the inner ring to the outer ring includes selecting a thickness of each web element such that when a load is applied, a substantial amount of the load is supported by a plurality of the web elements working in tension. A plurality of the radial web elements in a region above the axis of rotation are subjected to a tensile force while at least some of the radial web elements in a region between the load and a footprint region buckle and a plurality of the tangential web elements distribute the load through the flexible interconnected web. The step of connecting the inner ring to the outer ring includes selecting an elliptical transitional element for each of the plurality of vertices, such that a thickness of an associated web element is varied along at least a portion of a length of the web element.

In yet another embodiment a non-pneumatic tire includes a generally annular inner ring that attaches to a wheel, a generally annular outer ring, and an interconnected web between the generally annular inner ring and the generally annular outer ring. The interconnected web defines a plurality of openings circumferentially spaced around the tire and radially spaced at varying distances from an axis of rotation, so as to support a load by working in tension. The interconnected web includes a plurality of web elements having a varying thickness, including a first plurality of web elements above the axis of rotation and a second plurality of web elements below the axis of rotation. The varying thickness of at least one of the plurality of web elements is caused by an elliptical transition at a vertex of the web element. The varying thickness is configured to facilitate buckling of the interconnected web. When a load is applied, the first plurality of web elements are subjected to a tensile force while the second plurality of web elements buckle.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a front view of an undeformed nonpneumatic tire.

FIG. 2 is a front view of the non-pneumatic tire of FIG. 1 being deformed when subjected to a load.

FIG. 3 is a sectional perspective view of the undeformed non-pneumatic tire taken along line 3-3 in FIG. 1.

FIG. 4 is a front view of another embodiment of an undeformed non-pneumatic tire.

FIG. 5 is a front view of yet another embodiment of an undeformed non-pneumatic tire.

FIG. 6 is a front view of still another embodiment of an undeformed non-pneumatic tire.

FIG. 7 is a front view of yet another embodiment of an undeformed non-pneumatic tire.

FIG. 8 is a front view of still another embodiment of an undeformed non-pneumatic tire.

FIG. 9 is a front view of yet another embodiment of an undeformed non-pneumatic tire.

FIG. 10A is a front view of yet another embodiment of an undeformed non-pneumatic tire.

FIG. 10B is a detail view of a web of the undeformed non-pneumatic tire of FIG. 10A.

FIG. 10C is a perspective view of a lower portion of the web of FIG. 10A being deformed when subjected to a load.

FIG. 11A is a detail view of a web of another embodiment of an undeformed non-pneumatic tire with a web having a variable thickness defined by a radius at each vertex.

FIG. 11B is a perspective view of a lower portion of the web of FIG. 11A being deformed when subjected to a load.

FIG. 12 is a perspective view of a web portion of another embodiment of a non-pneumatic tire, wherein the web has a variable thickness defined by a larger radius at each vertex.

FIG. 13A is a detail view of a web of yet another embodiment of an undeformed non-pneumatic tire, wherein the web has a variable thickness defined by an elliptical transition at each vertex.

FIG. 13B is a perspective view of a lower portion of the web of FIG. 13A being deformed when subjected to a load.

FIG. 14A is a detail view of a web of yet another embodiment of an undeformed non-pneumatic tire, wherein the web has a variable thickness defined by a variable transition at each vertex.

FIG. 14B is a perspective view of a lower portion of the tire of FIG. 14A being deformed when subjected to a load.

FIG. 14C is a detail view of the area C of FIG. 14A.

FIG. 14D is a detail view of the area D of FIG. 14A.

FIG. 14E is a detail view of the area E of FIG. 14A.

FIG. 14F is a detail view of the area F of FIG. 14A.

### DETAILED DESCRIPTION

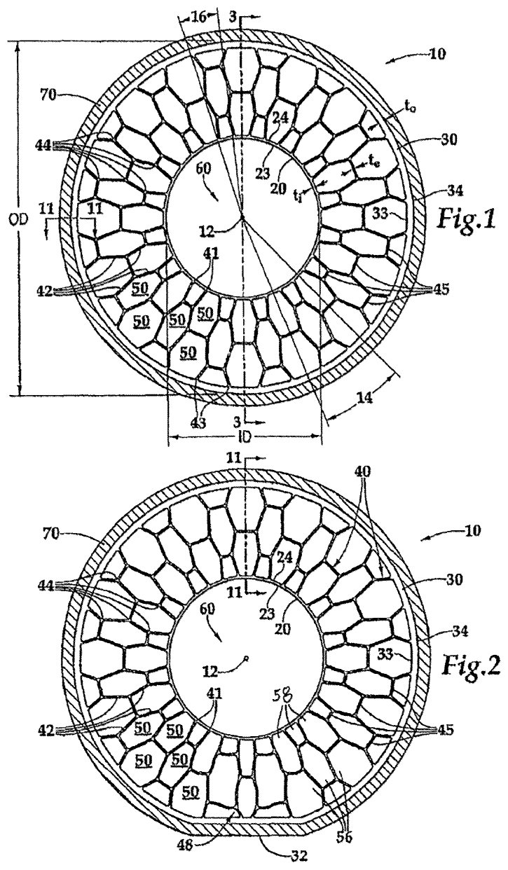

FIGS. 1, 2, and 3 illustrate one embodiment of a non-pneumatic tire 10. In the illustrated embodiment, the non-pneumatic tire 10 includes a generally annular inner ring 20 that engages a wheel 60 to which tire 10 is mounted. The wheel 60 has an axis of rotation 12 about which tire 10 spins. The generally annular inner ring 20 comprises an internal surface 23 and an external surface 24 and can be made of cross-linked or uncross-linked polymers. In one embodiment, the generally annular inner ring 20 can be made of a thermoplastic material such as a thermoplastic elastomer, a thermoplastic urethane, or a thermoplastic vulcanizate. In another embodiment, the generally annular inner ring 20 can be made of rubber, polyurethane, or other suitable material. In this application, the term “polymer” means cross-linked or uncross-linked polymers.

For smaller applied loads, the generally annular inner ring 20 can be adhesively engaged with wheel 60 or can undergo some chemical structure change allowing it to bond to the wheel 60. For larger applied loads, the generally annular inner ring 20 can be engaged to the wheel 60 via some form of a mechanical connection such as a mating fit, although a mechanical connection can be used for supporting smaller loads as well. The mechanical engagement can provide both the wheel 60 and the generally annular inner ring 20 with extra strength to support the larger applied load. In addition, a mechanical connection has the added benefit of ease of interchangeability. For example, if the non-pneumatic tire 10 needs to be replaced, generally annular inner ring 20 can be detached from wheel 60 and replaced. The wheel 60 can then be remounted to the axle of the vehicle, allowing the wheel 60 to be reusable. In another embodiment, the inner ring 20 can be connected to the wheel 60 by a combination of a mechanical and adhesive connection.

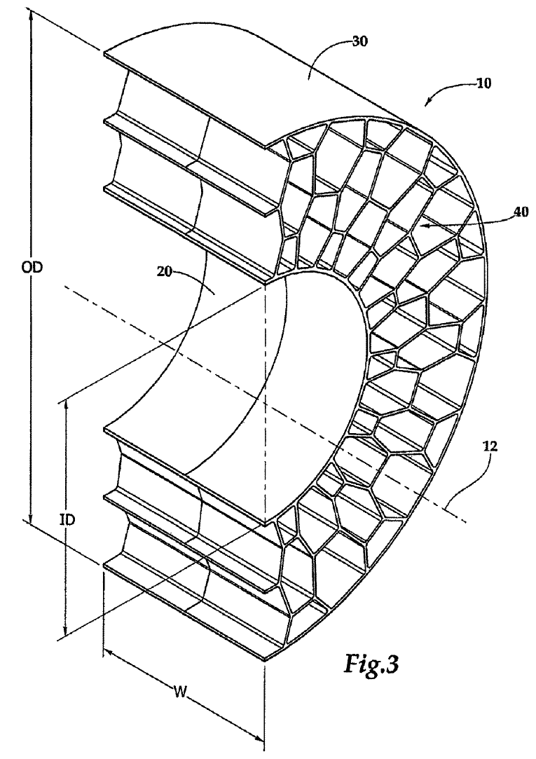

With continued reference to FIGS. 1, 2 and 3, the non-pneumatic tire 10 further comprises a generally annular outer ring 30 surrounding an interconnected web 40 (discussed below). The outer ring 30 can be configured to deform in an area around and including a footprint region 32 (see FIG. 2), which decreases vibration and increases ride comfort. However, since in some embodiments the non-pneumatic tire 10 does not have a sidewall, the generally annular outer ring 30, combined with the interconnected web 40, can also add lateral stiffness to the tire 10 so that the tire 10 does not unacceptably deform in portions away from the footprint region 32.

In one embodiment, the generally annular inner ring 20 and a generally annular outer ring 30 are made of the same material as interconnected web 40. For example, in one embodiment the inner ring, outer ring, and interconnected web are all comprised of a urethane material. The generally annular inner ring 20 and the generally annular outer ring 30 and the interconnected web 40 can be made by injection or compression molding, castable polymer, or any other method generally known in the art and can be formed at the same time so that their attachment is formed by the material comprising the inner ring 20, the outer ring 30 and the interconnected web 40 cooling and setting.

As shown in FIG. 1, the generally annular outer ring 30 can have a radially external surface 34 to which a tread carrying layer 70 is attached. Attachment can be done adhesively or using other methods commonly available in the art.

As shown in FIGS. 1, 2 and 3, the interconnected web 40 of non-pneumatic tire 10 connects the generally annular inner ring 20 to the generally annular outer ring 30. In the illustrated embodiment, the interconnected web 40 comprises at least two radially adjacent layers 56, 58 of web elements 42 that define a plurality of generally polygonal openings 50. In other words, with at least two adjacent layers 56, 58, a slice through any radial portion of the non-pneumatic tire 10 extending from the axis of the rotation 12 to the generally annular outer ring 30 passes through or traverses at least two generally polygonal openings 50. The polygonal openings 50 can form various shapes. In many embodiments, a majority of generally polygonal openings 50 can be generally hexagonal shape with six sides. However, it is possible that each one of the plurality of generally polygonal openings 50 has at least three sides. In one embodiment, the plurality of generally polygonal openings 50 are either generally hexagonal in shape or hexagonal in shape circumferentially separated by openings that are generally trapezoidal in shape, as can be seen in FIG. 1, giving interconnected web 40 a shape that can resemble a honeycomb.

A preferred range of angles between any two interconnected web elements (moving radially from the tread portion of the tire to the wheel) can be between 80 and 180 degrees (see, for example, the web elements of FIG. 1). Other ranges are also possible.

With continued reference to the illustrated embodiment of FIGS. 1, 2 and 3, the interconnected web 40 can be arranged such that one web element 42 connects to the generally annular inner ring 20 at any given point or line along the generally annular inner ring 20 such that there are a first set of connections 41 along the generally annular inner ring 20. Likewise, one web element 42 can connect to the generally annular outer ring 30 at any given point or line along an internal surface 33 of the generally annular outer ring 30 such that there are a second set of connections 43 along the generally annular outer ring 30. However, more than one web element 42 can connect to either the generally annular inner ring 20 or to the generally annular outer ring 30 at any given point or line.

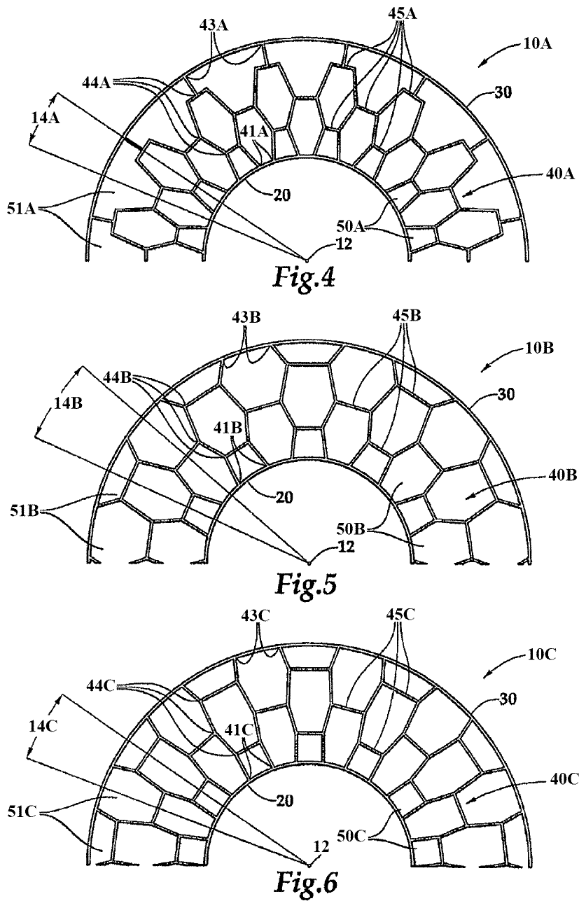

As shown in FIGS. 4-9, the interconnected web 40 can further comprise intersections 44 between web elements 42 in order to distribute an applied load throughout the interconnected web 40. In these illustrated embodiments, each intersection 44 joins at least three web elements 42. However, in other embodiments, the intersections 44 can join more than three web elements 42, which can assist in further distributing the stresses and strains experienced by web elements 42.

With continued reference to FIGS. 4-9, the web elements 42 can be angled relative to a radial plane 16 containing the axis of rotation 12 that also passes through web element 42. By angling the web elements 42, an applied load that is generally applied perpendicular to the axis of rotation 12 can be eccentrically applied to the web elements 42. This can create a rotational or bending component of an applied load on each web element 42, facilitating buckling of those web elements 42 subjected to a compressive load. Similarly situated web elements 42 can all be angled by about the same amount and in the same direction relative to radial planes 16. Preferably, however, the circumferentially consecutive web elements 42, excluding tangential web elements 45, of a layer of plurality of generally polygonal openings 50 are angled by about the same magnitude but measured in opposite directions about radial planes such that web elements 42 are generally mirror images about radial plane 16 of one another.

In addition to the web elements 42 that are generally angled relative to radial planes 16 passing through axis of rotation 12, the interconnected web 40 can also include tangential web elements 45, as shown in FIGS. 1-9. The tangential web elements 45 can be oriented such that they are generally aligned with tangents to cylinders or circles centered at axis of rotation 12. The tangential web elements 45 are preferred because they assist in distributing applied load. For example, when the applied load is applied, the web elements 42 in a region above axis of rotation 12 are subjected to a tensile force. Without the tangential web elements 45, interconnected web 40 may try to deform by having the other web elements 42 straighten out, orienting themselves in a generally radial direction, resulting in stress concentrations in localized areas. However, by being oriented in a generally tangential direction, the tangential web elements 45 distribute the applied load throughout the rest of interconnected web 40, thereby minimizing stress concentrations.

With continued reference to FIGS. 1-9 the plurality of generally polygonal openings 50 are shown wherein each one of the plurality of generally polygonal openings 50 is radially oriented. As noted above, the generally polygonal openings 50 can be oriented such that they are symmetrical about radial symmetry planes 14 that pass through axis of rotation 12. This arrangement can facilitate installation by allowing tire 10 to still function properly even if it is installed backwards because it should behave in the same manner regardless of its installed orientation.

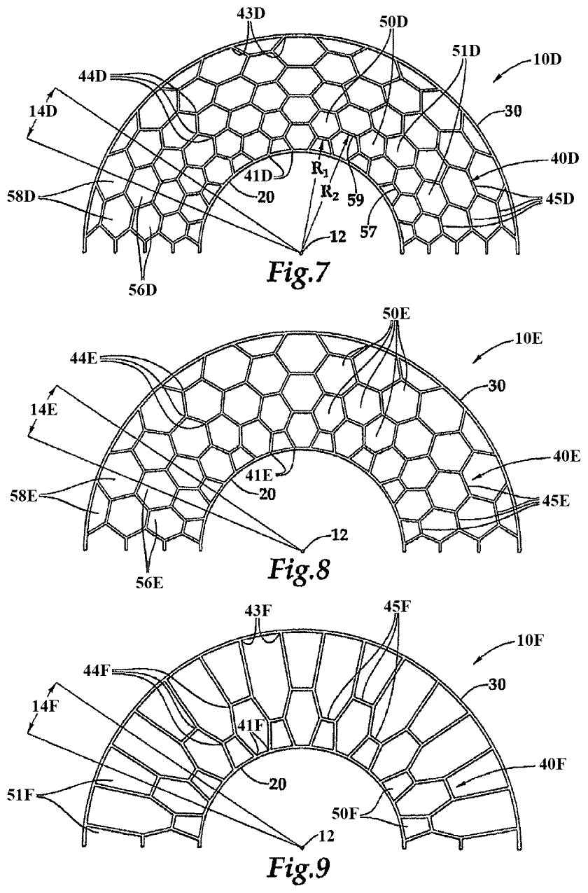

Each of the openings within the plurality of generally polygonal tubular openings 50 can, but is not required, to be similar in shape. FIG. 7, for example shows a first plurality of generally polygonal openings 50 that is different in shape from a second plurality of generally polygonal openings 51. In this embodiment, at least one opening of the first plurality of general polygonal openings 50 can be smaller than at least one opening of the second plurality of generally polygonal openings 51. FIG. 7 also shows that each generally polygonal opening in the first plurality of generally polygonal openings 50 has an inner boundary 57 spaced a radial distance, R₁, from axis of rotation 12 and each generally polygonal opening in the second plurality of generally polygonal openings 51, has a second inner boundary 59 spaced a radial distance, R₂, which can be greater than R₁, from axis of rotation 12.

The number of openings 50 within the interconnected web 40 can vary. For example, the interconnected web 40 can have five differently sized openings patterned 16 times for a total of 80 cells, such as in FIG. 1. In yet other embodiments, other numbers of openings 50 can be used other than 16. For example, in preferred embodiments the interconnected web 40 could include between 12-64 patterns of cells. Other numbers outside of this range are also possible.

As shown in FIGS. 7 and 8, openings in a radially inner layer 56 can be similarly shaped as compared to those in a radially outer layer 58 but can be sized differently from those openings such that the generally polygonal openings 50 increase in size when moving from opening to opening in a radially outward direction. However, a second plurality of generally polygonal openings in a radially outer layer can also be smaller than those in a first plurality of generally polygonal openings in a radially inner layer. In addition, the second plurality of generally polygonal openings can be either circumferentially separated from each other by a third plurality of generally polygonal openings 53 or can be greater in number than the first plurality of generally polygonal openings 50, or it can be both.

As noted above, FIGS. 1-9 show several variations of a plurality of generally polygonal openings 50 that are generally hexagonally shaped. These openings can be symmetrical in one direction or in two directions. In an alternative embodiment, they are not symmetrical. For example, in FIG. 1, radial symmetry planes 14 bisect several of the plurality of generally polygonal openings 50. Those openings are generally symmetrical about radial symmetry planes 14. However, interconnected web 40 of tire 10 can also be generally symmetrical as a whole about radial symmetry planes. In comparison, a second plurality of generally polygonal openings 14 can be generally symmetrical about similar radial symmetry planes 14. In addition, as shown in FIGS. 7 and 8, a second plurality of generally polygonal openings can be generally symmetrical about lines tangent to a cylinder commonly centered with axis of rotation 12, providing a second degree of symmetry.

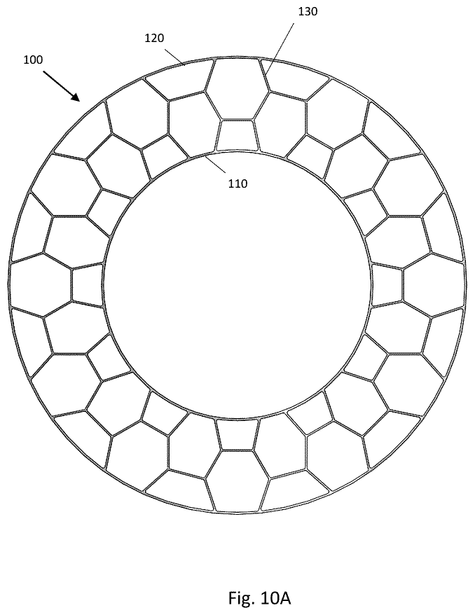

The web elements 42 can have varying lengths from one embodiment to another or within the same embodiment. For example, the interconnected web 40 in FIG. 7 comprises web elements 42 that are generally shorter than web elements of the interconnected web shown in FIG. 6. As a result, interconnected web 42 can appear denser in FIG. 7, with more web elements 42 and more generally polygonal openings 50 in a given arc of tire 10. FIG. 9 shows an interconnected web 40 with web elements 42 that substantially vary in length within the same interconnected web. Radially inward web elements 42 are generally shorter than web elements 42 located comparatively radially outward.

With reference back to FIG. 2, the combination of the geometry of interconnected web 40 and the material chosen in interconnected web 40 can enable an applied load to be distributed throughout the web elements 42. Because the web elements 42 are preferably relatively thin and can be made of a material that is relatively weak in compression, those elements 42 that are subjected to compressive forces may have a tendency to buckle. These elements are generally between the applied load that generally passes through axis of rotation 12 and footprint region 32 and are represented as buckled section 48 in FIG. 2.

In one embodiment, some or all of the web elements 42 can be provided with weakened (e.g., previously bent) or thinned sections such that the web elements 42 preferentially bend or are biased to bend in a certain direction. For example, in one embodiment, the web elements are biased such that they bend generally in an outwardly direction. In this manner, web elements do not contact or rub against each as they buckle. In addition, the position of the weakened or thinned portion can be used to control the location of the bending or buckling to avoid such contact.

When buckling occurs, the remaining web elements 42 may experience a tensile force. It is these web elements 42 that support the applied load. Although relatively thin, because web elements 42 can have a high tensile modulus they can have a smaller tendency to deform but instead can help maintain the shape of the tread carrying layer 70. In this manner, the tread carrying layer 70 can support the applied load on the tire 10 as the applied load is transmitted by tension through the web elements 42. The tread carrying layer 70, in turn, acts as an arch and provides support. Accordingly, the tread carrying layer 70 is sufficiently stiff to support the web elements 42 that are in tension and supporting the load. A substantial amount of the applied load may be supported by the plurality of the web elements working in tension. For example, in one embodiment, at least 75% of the load is supported in tension, in another embodiment at least 85% of the load is supported in tension and in another embodiment at least 95% of the load is supported in tension. In other embodiments, less than 75% of the load can be supported in tension.

Although the generally annular inner ring 20, the generally annular outer ring 30, and the interconnected web 40 can be constructed of the same material, they can all have different thicknesses. That is, the generally annular inner ring can have a first thickness, tᵢ, the generally annular outer ring can have a second thickness, tₒ, and the interconnected web can have a third thickness, tₑ. In the embodiment shown in FIG. 1, the first thickness tᵢ can be less than the second thickness tₒ. However, the third thickness, tₑ, can be less than either first thickness, tᵢ, or the second thickness, tₒ. Thinner web elements 42 buckles more easily when subjected to a compressive force whereas a relatively thicker generally annular inner ring 20 and the generally annular outer ring 30 can advantageously help maintain lateral stiffness of non-pneumatic tire 10 in an unbuckled region by better resisting deformation.

The thickness, tₑ, of web elements 42 can vary, depending on predetermined load capability requirements. For example, as the applied load increases, the web elements 42 can increase in thickness, tₑ, to provide increased tensile strength, reducing the size of the openings in the plurality of generally polygonal openings 50. However, the thickness, tₑ, should not increase too much so as to inhibit buckling of those web elements 42 subject to a compressive load. As with choice of material, the thickness, tₑ, can increase significantly with increases in the applied load. For example, in certain non-limiting embodiments, each web element 42 of interconnected web 40 can have a thickness, tₑ between about 0.04 inch and 0.1 inch thick for tire loads of about 0-1000 pounds, between about 0.1 and 0.25 inch thick for loads of about 500-5000 pounds, and between 0.25 and 0.5 inch thick for loads of about 2000 pounds or greater. Those of skill in the art will recognize that these thicknesses can be decreased or increased in modified embodiments.

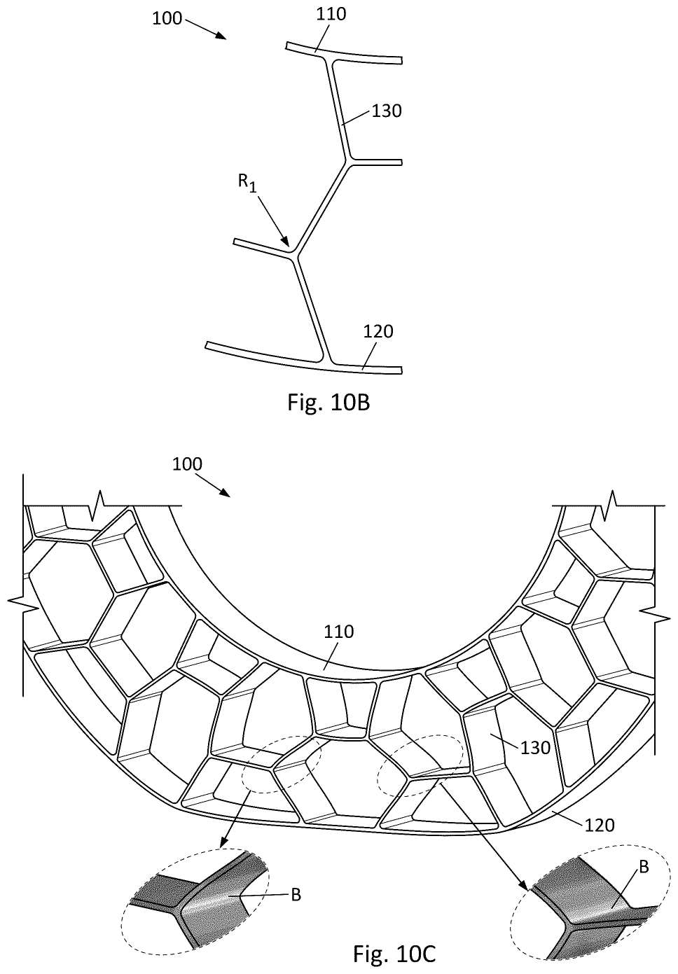

While the embodiments illustrated in FIGS. 1-9 include web elements 42 that each have a substantially constant thickness, tₑ, in alternative embodiments, the thickness of one or more web elements may vary. Exemplary effects of such variance are illustrated in FIGS. 10-14.

FIGS. 10A-C illustrate a reference tire 100 having a generally annular inner ring 110, a generally annular outer ring 120, and a plurality of web elements 130 that define polygonal openings. FIG. 10A provides a front of tire 100 in an undeformed state and FIG. 10B is a detail view of a portion of a web of the tire 100. In this particular embodiment, the web elements 130 form a plurality of hexagonal and substantially trapezoidal shapes, including an outer series of alternating hexagonal and trapezoidal opening and an inner series of alternating hexagonal and trapezoidal openings. The inner and outer openings are aligned such that a radial plane that bisects an inner hexagonal opening would also bisect an outer trapezoidal opening, and a radial plane that bisects an inner trapezoidal opening would also bisect an outer trapezoidal opening. In this embodiment, the radial plane that bisects an inner opening would only pass through two openings—the inner opening and a corresponding outer opening. It should be understood, however, that this arrangement is merely exemplary and is being used for illustrative purposes. In alternative embodiments, web elements that form any shape may be employed.

In the illustrated embodiment, each of the web elements 130 has substantially the same thickness along its length. As can be seen in FIG. 10B, each vertex of each polygonal opening is defined by a small radius R₁. The small radius R₁ is much smaller than the radial distance between the inner ring 110 and outer ring 120, and much smaller than the length of any given web element 130. Thus, there is only a negligible widening of each web element 130 as it approaches a vertex.

In one exemplary embodiment, the inner ring 110 has a diameter of 12.690 inches (32.232 cm) and the outer ring 120 has a diameter of 21.917 inches (55.669 cm). Thus, the radial distance between the inner ring 110 and the outer ring 120 is 4.614 inches (11.720 cm). In this embodiment, the web elements 130 have lengths between 1.508 inches (3.830 cm) and 1.798 inches (4.567 cm), and a thickness of 0.080 inches (0.203 cm). Each vertex is defined by a small radius R₁ of 0.1 inches (0.254 cm). However, it should be understood that the tire 100 may have any dimensions such that the radius at the vertices of each web element 130 is less than or equal to 125% of the mean element thickness.

FIG. 10C is a perspective view of a lower portion of the web being deformed when subjected to a load. FIG. 10C further includes detail views of selected regions to illustrate exemplary stresses on the web elements. In this embodiment, the web elements 130 are subject to high stresses at each vertex as the tire 100 rotates while subjected to a load. Moreover, the high stresses are concentrated in a narrow band B.

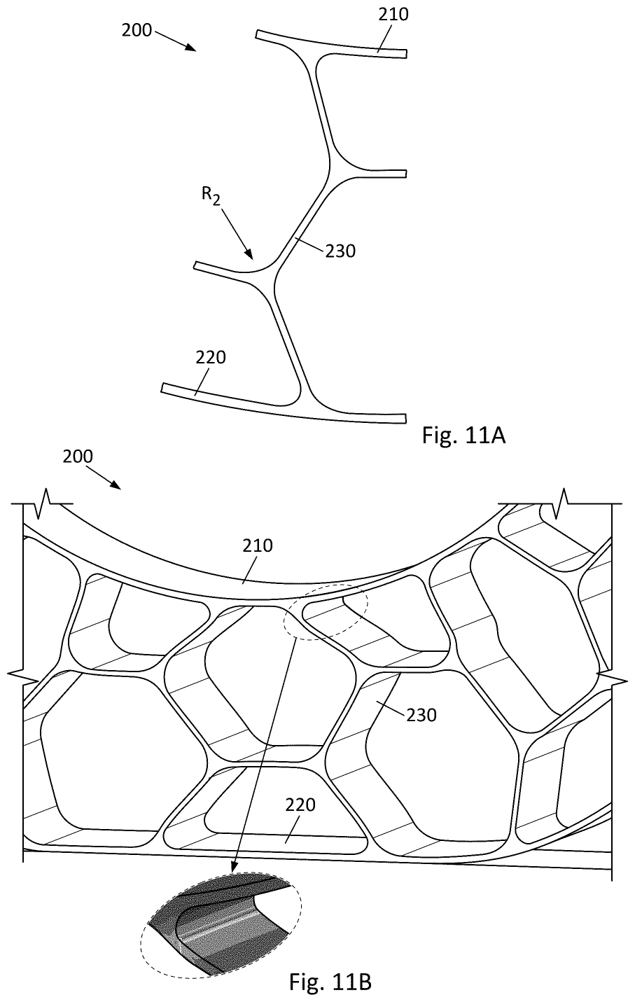

By contrast, FIGS. 11A-B illustrate a first variable thickness tire 200, i.e., a non-pneumatic tire with a web having a variable thickness defined by a larger radius at each vertex. FIG. 11A is a detail view of a web of the first variable thickness tire 200, including a generally annular inner ring 210, a generally annular outer ring 220, and a plurality of web elements 230 that define polygonal openings. The first variable thickness tire 200 has the same shapes and dimensions as the reference tire 100, except that each vertex of each polygonal opening is defined by a medium radius R₂.

In one exemplary embodiment, the first variable thickness tire 200 has the same dimensions as those described for the exemplary reference tire 100, except the medium radius R₂ is 0.5 inches (1.27 cm). Thus, the first variable thickness tire 200 is dimensioned such that the radius at the vertices of each web element 230 is 625% of the mean element thickness. In one embodiment, the radius is selected to be 400% to 800% of the mean element thickness. In other embodiments, the radius is selected to be greater than 125% of the mean element thickness.

FIG. 11B is a perspective view of a lower portion of a web of the first variable thickness tire 200 being deformed when subjected to a load. FIG. 11B further includes detail views of selected regions to illustrate exemplary stresses on the web elements. In this embodiment, when compared to the reference tire 100 the web elements 230 are subject to relatively lower stresses at each vertex as the tire 200 rotates while subjected to a load. Additionally, the small radius transition was effective at removing the narrow stress band. However, the location of high stress concentration changed and resulted in an even higher stress value, and the stresses are still more highly concentrated than may be desirable.

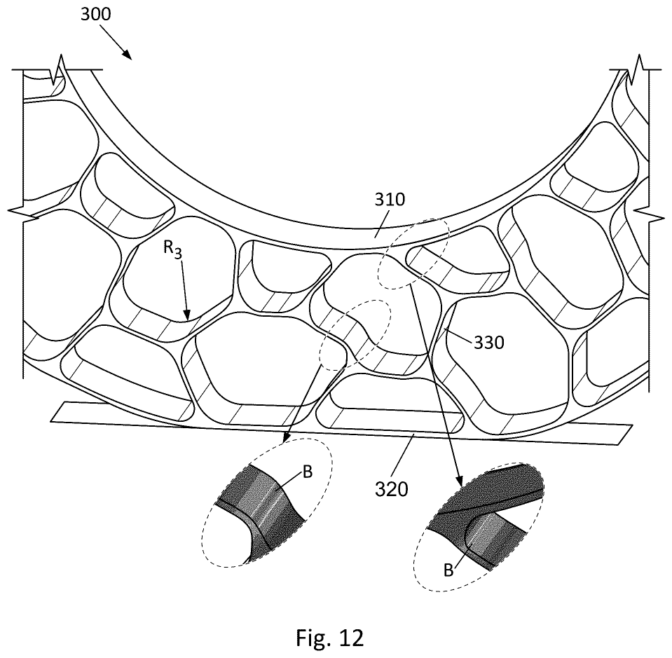

FIG. 12 is a perspective view of a lower portion of a web of a second variable thickness tire 300. Here, the web has a variable thickness defined by a larger radius at each vertex. FIG. 12 further includes detail views of selected regions to illustrate exemplary stresses on the web elements. The second variable thickness tire 300 has a generally annular inner ring 310, a generally annular outer ring 320, and a plurality of web elements 330 that define polygonal openings. The second variable thickness tire 300 has the same shapes and dimensions as the reference tire 100, except that each vertex of each polygonal opening is defined by a large radius R₃.

In one exemplary embodiment, the second variable thickness tire 300 has the same dimensions as those described for the exemplary reference tire 100, except the large radius R₃ is 0.7 inches (1.78 cm). Thus, the second variable thickness tire 300 is dimensioned such that the radius at the vertices of each web element 330 is 875% of the mean element thickness. In one embodiment, the radius is selected to be 800% to 1000% of the mean element thickness.

In this embodiment, when compared to the reference tire 100 the web elements 330 are subject to higher stresses at each vertex as the tire 300 rotates while subjected to a load. The large radius R₃ results in too much material at the junctions, reducing the effective length of the flexible section of each web element 330. The stresses are concentrated in a slightly wider band B, which has shifted to yet another location.

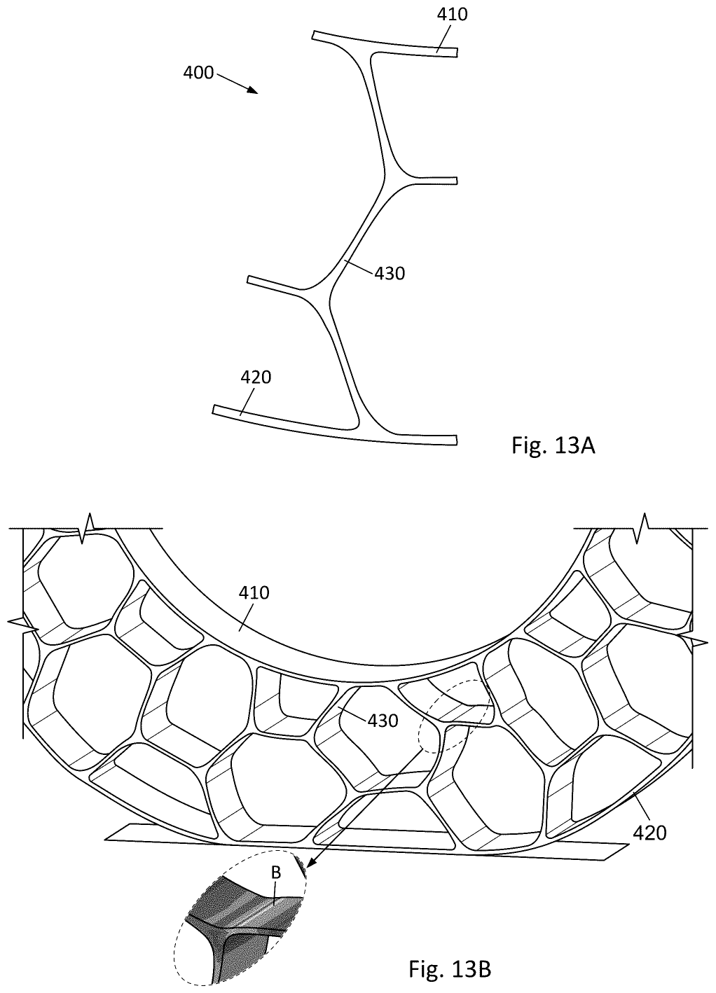

FIGS. 13A-B illustrate a third variable thickness tire 400, i.e., a non-pneumatic tire with a web having a variable thickness defined by an elliptical transition at each vertex. FIG. 13A is a detail view of a web of the third variable thickness tire 400, including a generally annular inner ring 410, a generally annular outer ring 420, and a plurality of web elements 430 that define polygonal openings. The third variable thickness tire 400 has the same shapes and dimensions as the reference tire 100, except that each vertex of each polygonal opening is defined by an elliptical transition.

In one exemplary embodiment, the third variable thickness tire 400 has the same dimensions as those described for the exemplary reference tire 100, except where the vertices include an elliptical portion. The elliptical shape allows for a two dimension definition of the transition. The use of an elliptical shape also allows for a reduction of material at each of the vertices that resulted from the use of a simple radius. The extra material from the simple radius contributed to the inflexible behaviors that were observed during tests.

FIG. 13B is a perspective view of a lower portion of the web of the third variable thickness tire 400 being deformed when subjected to a load. FIG. 13B further includes detail views of selected regions to illustrate exemplary stresses on the web elements 430. In this embodiment, the web elements 430 are subject to significantly lower stresses at each vertex as the tire 400 rotates while subjected to a load. The stresses are distributed in a wider band near the outer ring 420, but are still concentrated in a narrow band B near the inner ring 410. Ultimately, this embodiment still included too much material at the transitions.

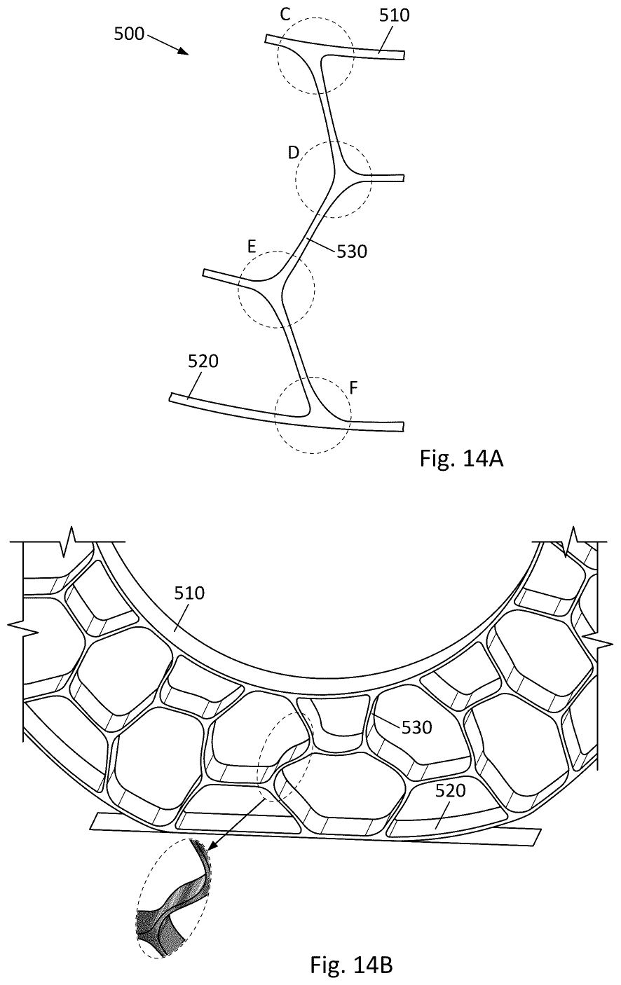

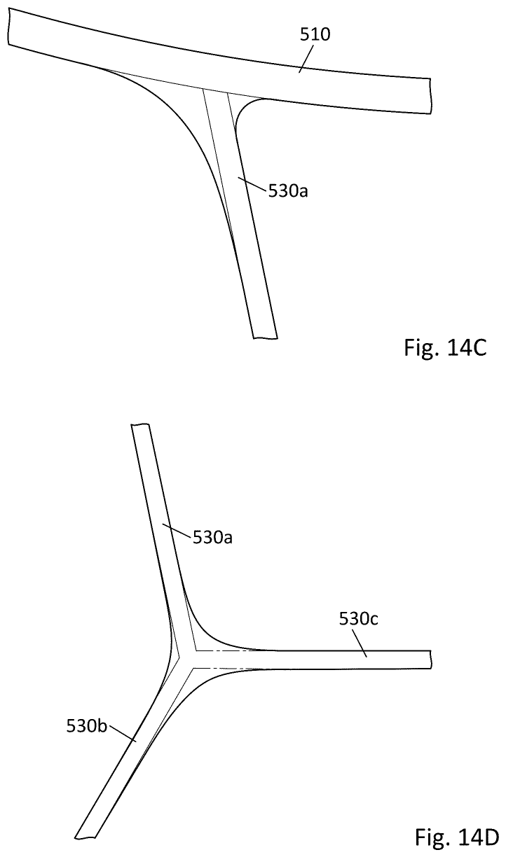

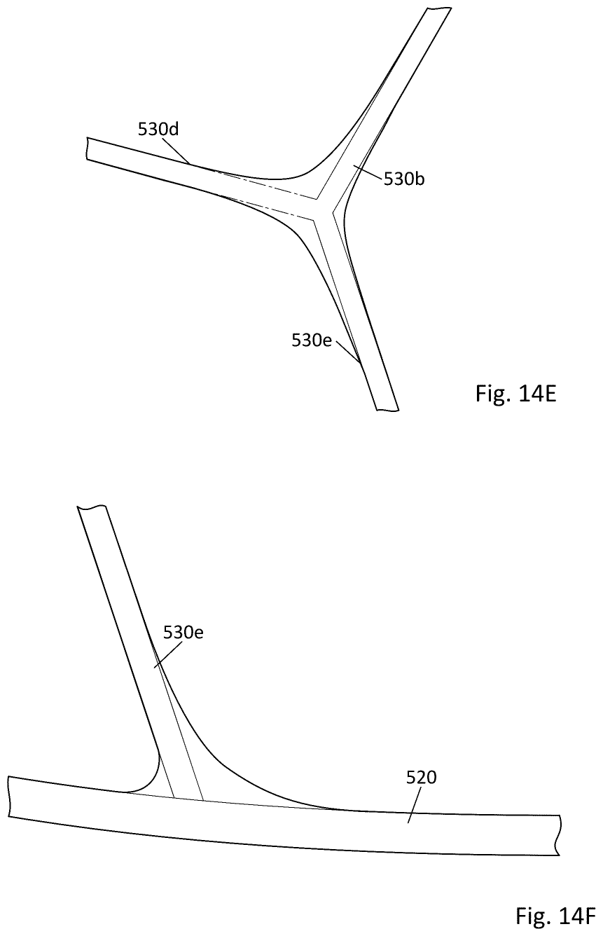

FIGS. 14A-14F illustrate a fourth variable thickness tire 500, i.e., a non-pneumatic tire with a web having a variable thickness defined by variable transitions at each vertex. FIG. 14A is a detail view of a web of the fourth variable thickness tire 500, including a generally annular inner ring 510, a generally annular outer ring 520, and a plurality of web elements 530 that define polygonal openings. The fourth variable thickness tire 500 has the same shapes and dimensions as the reference tire 100, except that each vertex of each polygonal opening is defined by a selected radial or spline transition.

FIG. 14B is a perspective view of a lower portion of the web of the fourth variable thickness tire 500 being deformed when subjected to a load. FIG. 14B further includes detail views of selected regions to illustrate exemplary stresses on the web elements 530. In this embodiment, the web elements 530 are subject to significantly lower stresses at each vertex as the tire 500 rotates while subjected to a load. The stresses are distributed in wide bands throughout the webbing. In one embodiment, the use of fully variable transitions led to approximately a 30% reduction of peak stress under normal operations.

Examples of the variable transitions are shown further in the detail views of FIGS. 14C-14F.

FIG. 14C is a detail view of the area C of FIG. 14A. In this area, two vertices between an inner web element 530a and the inner ring 510 are shown. From this view, an obtuse left-side angle and an acute right-side angle are formed between the inner web element 530a and the inner ring 510. The obtuse left-side angle is smoothed by a manually shaped spline that adds more material to the left of the center line of the inner web element 530a. The acute right-side angle is smoothed by a small, simple radius.

FIG. 14D is a detail view of the area D of FIG. 14A. In this area, three vertices are shown, including a left vertex between the inner web element 530a and an intermediate web element 530b, an upper right vertex between the inner web element 530a and an inner radial web element 530c, and a lower right vertex between the intermediate web element 530b and the inner radial web element 530c. In this area, all three vertices are defined by manually shaped splines.

FIG. 14E is a detail view of the area E of FIG. 14A. In this area, three vertices are shown, including an upper left vertex between the intermediate web element 530b and an outer radial web element 530d, a right vertex between the intermediate web element 530b and an outer web element 530e, and a lower left vertex between the outer radial web element 530d and the outer web element 530e. In this area, all three vertices are defined by manually shaped splines.

FIG. 14F is a detail view of the area F of FIG. 14A. In this area, two vertices between the outer web element 530e and the outer ring 520 are shown. From this view, an acute left-side angle and an obtuse right-side angle are formed between the outer web element 530e and the outer ring 520. The obtuse right-side angle is smoothed by a manually shaped spline that adds more material to the left of the center line of the outer web element 530e. The acute left-side angle is smoothed by a small, simple radius.

While the specific transitions of FIGS. 14A-14F are described above, it should be understood that each transition should be determined according to the particular geometry of a non-pneumatic tire and its associated webbing. In one embodiment, machine learning or other artificial intelligence may be employed in the selection of the transition.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present disclosure has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the disclosure, in its broader aspects, is not limited to the specific details, the representative system and method, and illustrative examples shown and described. Accordingly, departures may be made from such details without departing from the spirit or scope of the applicant's general inventive concept.

What is claimed is:

1. A non-pneumatic tire comprising:
a generally annular inner ring having an axis of rotation;
a deformable generally annular outer ring; and
a flexible interconnected web extending between the inner and the outer ring, the interconnected web including at least two radially adjacent layers of web elements at every radial cross-section of the tire, the web elements defining a plurality of generally polygonal openings and including a plurality of radial web elements that are angled relative to a plane that extends radially through the axis of rotation and a plurality of distinct tangential web elements that are generally transverse to the radial plane,
wherein each generally polygonal opening is defined by a plurality of vertices,
wherein each of the plurality of vertices is defined by an elliptical transitional element that varies a thickness of an associated web element along at least a portion of a length of the web element,
wherein each elliptical transitional element forms a single concave surface at each of the plurality of vertices, without any protruding surface,
wherein when load is applied, a substantial amount of the load is supported by a plurality of the web elements working in tension,
wherein a plurality of the radial web elements in a region above the axis of rotation are subjected to a tensile force while at least some of the radial web elements in a region between the load and a footprint region buckle and a plurality of the tangential web elements distribute the load through the flexible interconnected web.

2. The non-pneumatic tire of claim 1, wherein each of the web elements has a mean thickness between 0.04 inches and 0.5 inches.

3. The non-pneumatic tire of claim 1, wherein at least 75% of the load is supported in tension.

4. The non-pneumatic tire of claim 1, wherein the inner ring, the outer ring, and the flexible interconnected web are all constructed of the same material.

5. The non-pneumatic tire of claim 1, further comprising a tread carrying layer affixed to a radially external surface of the outer ring, the tread carrying layer support supporting the web elements working in tension.

6. The non-pneumatic tire of claim 1, wherein the plurality of generally polygonal openings comprises a first plurality of generally polygonal openings having a first shape and a second plurality of generally polygonal openings having a second shape different from the first shape.

7. The non-pneumatic tire of claim 6, wherein the first plurality of generally polygonal openings includes a plurality of inner hexagonal openings and a plurality of outer hexagonal openings, and wherein the second plurality of generally polygonal openings includes a plurality of inner trapezoidal openings and a plurality of outer trapezoidal openings.

8. The non-pneumatic tire of claim 7, wherein a radial plane that bisects an inner hexagonal opening would also bisect an outer trapezoidal opening, and a radial plane that bisects an inner trapezoidal opening would also bisect an outer trapezoidal opening.

9. A method of designing a non-pneumatic tire, the method comprising:
providing a generally annular inner ring having an axis of rotation;
providing a deformable generally annular outer ring; and
connecting the inner ring to the outer ring with a flexible interconnected web having at least two radially adjacent layers of web elements at every radial cross-section of the tire, such that the web elements define a plurality of generally polygonal openings having a plurality of vertices, and such that the web elements include a plurality of radial web elements that are angled relative to a plane that extends radially through the axis of rotation and a plurality of distinct tangential web elements that are generally transverse to the radial plane,
wherein the step of connecting the inner ring to the outer ring includes selecting a thickness of each web element such that when a load is applied, a substantial amount of the load is supported by a plurality of the web elements working in tension,
wherein a plurality of the radial web elements in a region above the axis of rotation are subjected to a tensile force while at least some of the radial web elements in a region between the load and a footprint region buckle and a plurality of the tangential web elements distribute the load through the flexible interconnected web,
wherein the step of connecting the inner ring to the outer ring includes selecting an elliptical transitional element for each of the plurality of vertices, such that a thickness of an associated web element is varied along at least a portion of a length of the web element, and
wherein each elliptical transitional element forms a single concave surface at each of the plurality of vertices, without any protruding surface.

10. The method of claim 9, wherein the selecting of a thickness of each web element includes selecting a thickness of each of web element such that each web element has a mean thickness between 0.04 inches and 0.5 inches.

11. The method of claim 9, wherein at least 75% of the load is supported in tension.

12. The method of claim 9, wherein the step of selecting a transitional element is performed by a machine learning process.

13. The method of claim 9, further comprising selecting a material for the inner ring, the outer ring, and the flexible interconnected web.

14. The method of claim 13, wherein the step of selecting a material for the inner ring, the outer ring, and the flexible interconnected web includes selecting a same material for the inner ring, the outer ring, and the flexible interconnected web.

15. The method of claim 13, wherein the step of selecting a thickness of each web element includes selecting the thickness according to material properties of the selected material.

16. A non-pneumatic tire comprising:
a generally annular inner ring that attaches to a wheel;
a generally annular outer ring;
an interconnected web between the generally annular inner ring and the generally annular outer ring, the interconnected web defining a plurality of openings circumferentially spaced around the tire and radially spaced at varying distances from an axis of rotation, so as to support a load by working in tension,
wherein the interconnected web includes a plurality of web elements having a varying thickness, including a first plurality of web elements above the axis of rotation and a second plurality of web elements below the axis of rotation,
wherein the varying thickness of at least one of the plurality of web elements is caused by an elliptical transition at a vertex of the web element,
wherein the varying thickness is configured to facilitate buckling of the interconnected web,
wherein, when a load is applied, the first plurality of web elements are subjected to a tensile force while the second plurality of web elements buckle.

17. The non-pneumatic tire of claim 16, wherein the plurality of openings comprises a first plurality of openings having a first shape and a second plurality of openings having a second shape different from the first shape.

18. The non-pneumatic tire of claim 17, wherein the first plurality of openings includes a plurality of inner hexagonal openings and a plurality of outer hexagonal openings, and wherein the second plurality of openings includes a plurality of inner trapezoidal openings and a plurality of outer trapezoidal openings.

19. The non-pneumatic tire of claim 18, wherein a radial plane that bisects an inner hexagonal opening would also bisect an outer trapezoidal opening, and a radial plane that bisects an inner trapezoidal opening would also bisect an outer trapezoidal opening.

20. The non-pneumatic tire of claim 16, further comprising a tread carrying layer affixed to a radially external surface of the outer ring.
